(19) United States
(12) Patent Application Publication
(10) Pub. No.: US 2009/0135492 A1
(43) Pub. Date: May 28, 2009

(54) ANTI-REFLECTIVE FILM, POLARIZER, LIQUID CRYSTAL DISPLAY ELEMENT AND DISPLAY ELEMENT

(76) Inventors: Kouji Kusuda, Mie (JP); Nobuhiko Nakai, Mie (JP)

Correspondence Address: NIXON & VANDERHYE, PC, 901 NORTH GLEBE ROAD, 11TH FLOOR, ARLINGTON, VA, 22203, US

(21) Appl. No.: 12/297,400

(22) PCT Filed: Mar. 30, 2007
(86) PCT No.: PCT/JP2007/057262

§ 371 Date: Oct. 16, 2008

(30) Foreign Application Priority Data
Nov. 8, 2006 (JP) 2006 220019

(51) Int. Cl. G02B 1/11; G02F 1/1335

(52) U.S. Cl. 359/601; 252/582

(57) ABSTRACT

The present invention provides an antireflective film, a polarizer, a liquid crystal display element, and a display element, each of which makes it possible for light reflected on a surface to which stains have adhered and on a surface where the stains have remained even after being wiped off to be recognized as an almost achromatic color, thereby suppressing the stains having adhered to the surface such as fingerprint from being recognized to shine in blue. The reflective display film of the present invention is an anti-reflective film which is placed on a base material and reduces light reflected on a surface of the base material, wherein a reflection spectrum of the anti-reflective film has a bottom wavelength of less than 550 nm.

### TECHNICAL FIELD

The present invention relates an anti-reflective film, a polarizer, a liquid crystal display element, and a display element. More specifically, the present invention relates to an anti-reflective film for preventing reflection of external light, and a polarizer, a liquid crystal display element, and a display element, each including such an anti-reflective film.

### BACKGROUND ART

It has been commonly known that an anti-reflective film is arranged on a surface of a display (display element) such as a cathode ray tube (CRT), a liquid crystal display (LCD), and a plasma display panel (PDP) in order to prevent reflection of external light. For example, in a liquid crystal display element, an anti-reflective film is arranged, for example, on an observation side surface of a polarizer. Two types: AG (Anti Glare) type; and clear type are commonly known as the anti-reflective film.

FIG. 7 is a cross-sectional view schematically showing a configuration of a conventional display element including an AG type anti-reflective film (hereinafter, also referred to as an “AG film”). As shown in FIG. 7, the AG film 5 has an irregular surface. The AG film 5 is arranged on an observation side surface of a base material film 2 arranged on a display 1 and scatters external light 4, whereby exhibiting an anti-glare effect. The AG type anti-reflective film can reduce specular reflection of external light, but if reflected light 4a that is reflected on the outermost surface of the AG film 5 is scattered too much due to the irregular shape, white turbidity (blur) is observed.

FIG. 8 is a cross-sectional view schematically showing a configuration of a conventional display element including a clear type anti-reflective film (hereinafter, also referred to as a clear film). As shown in FIG. 8, a clear film 3 is arranged on an observation side surface of the base material 2 arranged on the display 1. This configuration is designed in such a way that a phase of reflected light 4a that is reflected on the outermost surface of the clear film 3 is different from a phase of reflected light 4b that is reflected on the boundary surface between the clear film 3 and the base material 2 just by N−½ (N is an integer of 1 or more) According to the clear type anti-reflective film, the phase of the reflected light 4a that is reflected on the outermost surface of the clear film 3 is opposite to the phase of the reflected light 4b that is reflected on the boundary surface between the clear film 3 and the base material 2. Therefore, the phases cancel each other by interference. Using this, the reflectance can be reduced.

The clear type anti-reflective film is further classified into an AR (Anti-Reflection) type and an LR (Low Reflection) type. The AR type anti-reflective film (hereinafter, also referred to as an AR film) is normally formed by a dry process, such as deposition and sputtering. The AR type anti-reflective film has a multilayer structure including four to seven layers. The LR type anti-reflective film (hereinafter, also referred to as an LR film) is normally constituted by a single layer or a few (two or three layers) layers. The LR film shows a reflectance higher than that of the AR film, but the LR film has a high productivity and costs on it are low. Therefore, such an LR film is often used in a display which is used indoors where influences by external light are small.

As mentioned above, the clear type anti-reflective film reduces the reflectance by light interference. Therefore, conditions for reducing the reflectance are determined depending on a wavelength of external light. As shown in FIG. 9, a spectrum of reflected light whose reflectance is reduced by the clear type anti-reflective film has a shape the bottom of which is at a specific wavelength, normally. In FIG. 9, the reflectance is an integrating sphere reflectance measured using a spectrophotometer (product of Hitachi High-Technologies Corporation, trade name: U-4100).

As shown in FIG. 9, it is difficult in the clear type anti-reflective film that the reflectance is reduced uniformly in the entire wavelength region. In view of neutral color (achromatic color) in chromaticity of reflected light and luminous reflectance (Y value), a common anti-reflective film is designed in such a way that reflected light shows a spectrum whose bottom wavelength is 550 to 600 nm. Herein, the luminous reflectance means tristimulus values Y obtained from a spectrum of reflected light, a spectrum of light outputted from a standard light source, and color matching functions corresponding to sensitivity of a human eye. If the surface of the clear type anti-reflective film is touched by a bare hand and thereby a fingerprint adheres thereto, for example, the optical design is changed at the part where the fingerprint has adhered. As a result, the reflectance of blue is increased, as shown in FIG. 10. Therefore, the part where the fingerprint has adhered is recognized to shine in blue. Even if the fingerprint is wiped off, the fingerprint is not completely removed and the sebum remains, generally. In such a case, the remained sebum is recognized to shine in blue. In this point, the clear type anti-reflective film has room for improvement in order to prevent a reduction in display qualities even in the case that stains such as a fingerprint adheres to the surface of the clear type anti-reflective film.

With regard to the wavelength where the reflectance of light reflected through the anti-reflective film is minimum, it has been known that, in a projection type display device, an anti-reflective film which is designed to show the smallest reflectance for light at a wavelength of 400 to 500 nm is arranged on a surface of a polarizer, in order to prevent return light from an output side from entering a TFT (thin film transistor) liquid crystal panel, thereby preventing a reduction in image qualities due to an increase in leakage current (for example, refer to Patent Document 1). However, Patent Document 1 neither discloses nor suggests a method of preventing the reduction in display qualities in the case that stains such as a fingerprint adheres to the film surface.

### [Patent Document 1]

Japanese Nokai Publication No. Hei-09-96805

### DISCLOSURE OF INVENTION

The present invention has been made in view of the above-mentioned state of the art. The present invention has an object to provide an anti-reflective film, a polarizer, a liquid crystal display element, and a display element, each capable of suppressing stains such as a fingerprint which has adhered to a surface of the anti-reflective film from being recognized to shine in blue.

The present inventors made various investigations on an anti-reflective film attached to a surface of a display element in order to prevent reflection of external light. The inventors noted that if a fingerprint adheres to a surface of the anti-reflective film, the fingerprint shines in blue, which results in deterioration of display qualities. Then, the inventors found that the reason why the part where the fingerprint has adhered is recognized to shine in blue is as follows. In the case that a fingerprint adheres to the surface of the anti-reflective film, a refractive index of the anti-reflective film increases. Therefore, the bottom wavelength of the reflection spectrum is shifted to the long-wavelength region and the reflectance in the short-wavelength region is increased. Further, in the case that the fingerprint adheres to the surface of the anti-reflective flit, a length of an optical path is substantially extended. Further, the inventors found that if the reflection spectrum has a bottom wavelength of less than 550 nm, the increase in reflectance in the short-wavelength region, due to the fingerprint adherence to the anti-reflective film, can be reduced. As a result, it is possible to suppress the fingerprint from shining in blue. Thus, the above-mentioned problems have been admirably solved, leading to completion of the present invention.

That is, the present invention is an anti-reflective film which is placed on a base material and reduces light reflected on a surface of the base material, wherein a reflection spectrum of the anti-reflective film has a bottom wavelength of less than 550 nm.

The present invention is mentioned in more detail below.

The anti-reflective film of the present invention is placed on a base material and reduces a light reflected on a surface of the base material. That is, according to the anti-reflective film of the present invention, light reflected on the base material surface and light reflected on the anti-reflective film surface cancel each other by interference, whereby reducing the reflectance. Specifically, with regard to light at a wavelength λ, satisfying the following formula (I), where n is a refractive index of the anti-reflective film; d is a thickness of the anti-reflective film; and N is an integer of 1 or more, a difference in phase between light reflected on the base material surface and light reflected on the anti-reflective film surface is an odd multiple of ½ wavelength. Hence, these lights cancel each other by interference, in principle.

n×2d=(N−½)λ (1)

A transparent material is preferably used for the above-mentioned anti-reflective film. For example, an organic material such as fluorine resin, and an inorganic material such as silicon dioxide (SiO₂), indium tin oxide (ITO) may be used.

In the present invention, it is preferable that a reflection spectrum of the anti-reflective film has a bottom wavelength of less than 550 nm. In the present description, the bottom wavelength of the reflection spectrum means a wavelength where the reflection spectrum of the anti-reflective film shows the smallest reflectance if the anti-reflective film which is positioned on the base material is measured for the reflection spectrum. The bottom wavelength satisfies the above formula (I). The reflection spectrum may be measured under the following conditions, for example. With regard to a light source, a heavy hydrogen lamp is used to radiate UV light, and a 50 W halogen lamp is used to radiate visible/infrared lights; and a φ60 nm integrating sphere whose inner surface is coated with BaSO₄ is irradiated with reflected light at an incident angle of 10°; and a base material which shows a reflectance not depending on a wavelength is used as the base material; a measurement wavelength range is 380 to 780 nm (visible light region). A base material which shows a reflectance depending on a wavelength may be used, but in such a case, a reflectance attributed to the wavelength dependence of the base material is calculated and subtracted.

FIG. 1 is a graph schematically showing a change in reflection spectrum, due to adherence of a fingerprint, of the anti-reflective film of the present invention. In the case that the reflection spectrum has a bottom wavelength of less than 550 nm, a change in reflection spectrum in a blue wavelength region can be made smaller in comparison to that in a conventional case (FIG. 10), even if adherence of stains such as a fingerprint changes the reflection spectrum. Accordingly, according to the present invention, even if the anti-reflective film is arranged on a surface of the display element to which stains easily adhere, light reflected on the surface to which stains have adhered and on the surface where the stains have been removed but remained can be recognized as an almost achromatic color. Thus, the stains are less observed to practically have no influence on visibility. As a result, the reduction in display qualities can be suppressed. The stains whose influences on the display qualities are suppressed by the anti-reflective film of the present invention include a fingerprint that is a residue of sebum, sweat, and the like, and grease. The display qualities are adversely influenced by not only the stains which have adhered to the film surface but also those which have adhered to the film surface and then have been wiped off to be spread. In the present invention, it is possible to effectively prevent at least the stains which have adhered to the film surface and then have been wiped off to be spread from adversely influencing the display qualities.

The bottom wavelength of the reflection spectrum can be adjusted by changing the material (refractive index) and/or the thickness of the anti-reflective film, as shown in the above formula (1). Also in a conventional case, the bottom wavelength of the reflection spectrum is used as a characteristic of the anti-reflective film. However, it is just used as an index of a color of reflected light. In contrast, in the present invention, the bottom wavelength of the reflection spectrum is designed to have an optimal value based on technical reasons. As a result, the display qualities can be improved.

It is preferable that the reflection spectrum of the anti-reflective film has a bottom wavelength of more than 500 nm. The luminous reflectance becomes larger if the bottom wavelength is shifted to the low-wavelength region. As a result, external light is highly reflected. If the bottom wavelength is more than 500 nm and less than 550 nm, both of the reflection of external light and stains can be suppressed to have no influence on the visibility practically. With regard to the bottom wavelength, the bottom wavelength is more preferably more than 510 nm and less than 540, and still more preferably 530 nm. In the present description, when the phrase “more than X” is used, X is not included.

Preferable embodiments of the anti-reflective film of the present invention include: an embodiment in which the antireflective film is composed of a single layer; an embodiment in which the anti-reflective film is composed of two or three layers; and an embodiment in which the anti-reflective film is composed of four or more layers. That is, the anti-reflective film of the present invention may be an LR film composed of a single layer, an LR film composed of a plurality of layers, or an AR film. According to any of these embodiments, the operation and effects of the present invention can be sufficiently exhibited if the bottom wavelength of the reflection spectrum is less than 550 nm.

An embodiment in which a surface of the anti-reflective film is provided with a light scattering anti-glare treatment may be mentioned as a preferable embodiment of the anti-reflective film of the present invention. The light scattering anti-glare (AG) treatment means a treatment for providing the film with a structure for scattering external light. For example, a treatment for forming irregularities on the anti-reflective film surface may be mentioned. Not just using the anti-reflective film of the present invention, the light scattering anti-glare treatment is additionally adopted, and thereby the effect of preventing reflection of external light, attributed to the anti-reflective film of the present invention, can be more improved.

The present invention is also a polarizer including the anti-reflective film. The polarizer is an optical member having a function of transmitting only a specific polarization component of incident light. The structure of the polarizer is not especially limited, and, for example, it may be a structure in which a separator, a cohesive agent, a protective layer, a polarizing element, a protective layer, and a surface protective film are stacked in this order. The present invention is further a liquid crystal display element including the polarizer. The liquid crystal display element controls alignment of a birefringent liquid crystal molecule to control transmission/shielding (ON/OFF in display). According to the polarizer or the liquid crystal display element of the present invention, the reduction in display qualities, caused by the adherence of stains such as a fingerprint to the anti-reflective film surface, can be sufficiently suppressed. It is preferable that the anti-reflective film is arranged on an outermost surface of the liquid crystal display element. In the case that the anti-reflective film of the present invention is arranged on the outer most surface, the reduction in display qualities, caused by adherence of stains to the liquid crystal display element surface, can be effectively prevented.

The anti-reflective film of the present invention can be used in various display elements, in addition to the liquid crystal display element. That is, the present invention is also a display element including the anti-reflective film. According to the display element of the present invention, the reduction in display qualities, caused by adherence of stains such as a fingerprint to the anti-reflective film surface, can be sufficiently suppressed. Examples of the display element of the present invention include: a cathode-ray tube (CRT), a plasma display element (PDP), an organic electroluminescent display element, and a rear projection. In addition, it is preferable that the anti-reflective film is arranged on an outermost surface of the display element. In the case that the anti-reflective film of the present invention is arranged on the outermost surface, the reduction in display qualities, caused by adherence of stains to the display element surface, can be effectively prevented.

### EFFECT OF THE INVENTION

According to the anti-reflective film of the present invention, the change in reflectance in the blue wavelength region can be made smaller even if the reflection spectrum is changed due to adherence of stains such as a fingerprint to a surface of the anti-reflective film. As a result, light reflected on the surface to which stains have adhered and on the surface where stains have remained even after being wiped off can be recognized as an almost achromatic color. Therefore, it is possible to suppress the stains having adhered to the surface from being recognized to shine in blue.

### BEST MODES FOR CARRYING OUT THE INVENTION

The present invention is mentioned in more detail below with reference to Embodiments using drawings, but not limited to only these Embodiments.

### Embodiment 1

FIG. 2 is a cross-sectional view schematically showing a configuration of a display element of the present invention, and the display element includes an LR film as the anti-reflective film. According to the present Embodiment, a base material film 2 is arranged on a display 1 and thereon, an anti-reflective film 3a is arranged, as shown in FIG. 2. Examples of the display 1 include a liquid crystal display element, a cathode-ray tube (CRT), a plasma display element (PDP), an organic electroluminescent display element, and a rear projection. If the display 1 is a Liquid crystal display element, for example, an array substrate and a color filter substrate are arranged with a liquid crystal layer therebetween, and a polarizer is arranged on an outer surface of the array substrate and on an outer surface of the color filter substrate. As a result, the display 1 is completed. Examples of the base material film 2 include a polyethylene terephthalate (PET) film and a triacetyl cellulose (TAC) film. The base material film 2 may be composed of a single layer or a plurality of layers. According to the present Embodiment, the base material film 2 is arranged on the display 1, but the anti-reflective film 3a may be arranged on the display 1. The display 1 may include a touch panel screen on the surface thereof. In this case, this touch panel is operated by touching the anti-reflective film 3a positioned on the outermost surface by a finger and the like. Hence, stains such as a fingerprint often adhere to the surface of the anti-reflective film, and therefore the structure of the present invention is particularly effective for such a display.

According to the present Embodiment, an LR film is used as the anti-reflective film 3a. The LR film is composed of a single layer or a few layers (for example, two or three layers). The LR film shows a function of preventing reflection. The luminous reflectance of the LR film is normally about 1 to 3%. An LR film which is made of a material with a low refractive index can show a luminous reflectance of about 1%.

The LR film has a simple layer structure, and therefore it can be formed by a wet coating method. Examples of typical wet coating methods include a kiss reverse method, a wire bar coating method, and a slit die coating method. The kiss reverse method shown in FIG. 3(a) is a method in which a coating liquid 7 is moved from a coating liquid-filled container 9 to a groove of a gravure 8, and the coating liquid 7 charged in the groove is transferred into the base material film 2. The wire bar method shown in FIG. 3(b) is a method in which using a structure in which wires 11 are wound around a shaft 10, a constant amount of the coating liquid 7 filled between the wires 11 is transferred to the base material film 2. The slit die method shown in FIG. 3(c) is a method in which a constant amount of the coating liquid 7 is applied to the base material film 2 with a die 12 having a slit. According to the slit die method, a constant amount of the coating liquid 7 charged in the die 12 is pumped to the die 12. The coating liquid 7 is not exposed to air, and therefore the coating liquid 7 is not deteriorated to form a film having a stable thickness.

The present invention can provide a greater effect for an LR film, which is normally inferior to an AR film in anti-reflection performance, rather than the AR film. This is because the LR film originally has a luminous reflectance more than that of the AR film, and due to the adherence of stains such as a fingerprint, the intensity of reflected light is further increased and easily reaches the luminous efficacy. Even if the anti-reflective film is composed of a plurality of layers, the great effect can be expected as long as the film has characteristics attributed to the LR film.

### Embodiment 2

FIG. 4 is a cross-sectional view schematically showing a configuration of a display element of the present invention, and the display element includes an LR film with which an AG treatment has been provided (hereinafter, also referred to as an AGLR film) as the anti-reflective film. According to the present Embodiment, the base material film 2 is arranged on the display 1 and thereon, an anti-reflective film 3b is arranged, as shown in FIG. 4. The present Embodiment is the same as Embodiment 1, except that the AGLR film is used as the anti-reflective film 3b. The AG film has irregularities on its surface and prevents glare of light by scattering external light. The AG film can reduce specular reflection of external light, but if the light is scattered too much by the irregularities on the AG surface, white turbidity (blur) is observed. In contrast, according to the AGLR film, the characteristics attributed to the AG treatment and the characteristics of the LR film can be exhibited together, as shown in FIG. 5. As a result, the white turbidity (blur) due to the AG film is suppressed and simultaneously reflection of external light due to the LR film can be sufficiently suppressed. In addition, the AGLR film makes it possible to provide an anti-reflective film less expensive than the AR film.

The present invention can exhibit a great effect also for the AGLR film. This is because the AGLR film surface has irregularities and a fingerprint which has adhered to these irregularities tends to remain because it is harder to wipe off.

### Embodiment 3

FIG. 6 is a cross-sectional view schematically showing a configuration of a display element of the present invention, and the display element includes an AR film as the anti-reflective film. According to the present Embodiment, the base material film 2 is arranged on the display 1, and thereon, an anti-reflective film 3c is arranged, as shown in FIG. 6. The present Embodiment is the same as Embodiment 1, except that the AR film is used as the anti-reflective film 3c. The AR film 3c is normally formed by a dry process. The AR film has a multilayer structure composed of about 4 to 7 layers and has a low luminous reflectance of about 0.2%. A deposition method, a sputtering method, and the like are preferably used for forming the AR film 3c. In the deposition method, a film material is heated, dissolved, and evaporated under vacuum, thereby being deposited to an object. According to the sputtering method, a voltage of several hundreds of volts is applied between a vacuum container into which inert gas is introduced and an electrode (target) formed of a film material. At this time, due to energy of discharge, particles of the inert gas are positively charged and these positively-charged particles are strongly attracted to and impact on a negatively charged electrode. As a result, particles ejected from a part of the film material are sputtered to form a film on an object. A DC magnetron sputtering method is mentioned as a typical one.

The productivity of the AR film is low because time taken to form the AR film is difficult to shorten, and therefore it is not suitably used in large-sized devices. However, the AR film is excellent in an effect of suppressing reflection of external light, and hence it can be preferably used, for example, in mobile devices which are used under bright external light, e.g., out of doors.

### “Evaluation Test”

AGLR films having the same configuration as that of the anti-reflective film in accordance with Embodiment 2 were prepared to be used as evaluation samples. These evaluation samples were different in thickness, and therefore, their reflection spectra had different bottom wavelengths. The bottom wavelengths of the reflection spectra of the evaluation samples were 450 nm, 480 nm, 500 nm, 510 nm, 520 nm, 530 nm, 540 nm, 550 nm, 560 nm, 580 nm, 600 nm, and 630 nm. With regard to the evaluation samples, the Haze value was 24% and the refractive index of the anti-reflective film was 1.3.

### (1) Fingerprint Visibility

Polarizers are attached to both surfaces of a liquid crystal panel in a Cross-Nicol arrangement. A fingerprint was put on the polarizer surface on a display surface side. Then, the fingerprint was wiped off five or six times with a wiping cloth (product of Kanebo Synthetic Fibers, Ltd., trade name: Savina). Then, light at 300 to 2200 lux (fluorescent light or outdoor light) was radiated to the liquid crystal panel under the following conditions: black is displayed on the liquid crystal panel; no voltage is applied to the liquid crystal (OFF state); and backlight is off. In such a manner, existence of the fingerprint which had been wiped off (a residue of sebum and sweat) was visually observed and evaluated based on the following criterion.

Excellent: No fingerprint is observed.
Good: Fingerprint is slightly observed by careful observation, but it has no problem in practical use.
Average: Fingerprint is slightly observed.
Bad: Fingerprint is clearly observed.

In order to uniform the thickness of the fingerprint, the fingerprint was wiped off, and after that, the evaluation was performed. In addition, the fingerprint which still remains even after being wiped off with a cloth is the biggest problem in practical use. If the evaluation is performed without wiping off the fingerprint, uneven fingerprint tends to be recognized, and a variation in visibility will be large. This might be because the thickness of the fingerprint is large and varies.

### (2) Reflection of External Light

Reflection of external light on the display surface was evaluated. For evaluation, the sample was irradiated with light at 300 to 2200 lux (fluorescent light or outdoor light) and the level of the reflection of external light was evaluated by eye observation under the following criterion.

Excellent: Reflection of external light is not recognized at all.
Good: Reflection of external light is recognized by careful observation, but it has no problem in practical use.
Average: Reflection of external light is slightly recognized.
Bad: Reflection of external light is recognized.

### (3) Luminous Reflectance

The evaluation sample was attached to a glass substrate whose back surface was provided with a black tape. This prepared glass substrate was subjected to reflection spectrum measurement (spectrophotometer: product of Hitachi High-Technologies Corporation, tradename: U-4100, light source: ultraviolet area=heavy hydrogen lamp, visible/infrared region=50 W halogen lamp, integrating sphere: φ60 mm, the inner surface was coated with BaSO₄, incident angle: 10°, wavelength: 380 nm to 780 nm). The visual efficacy was corrected in accordance with the XYZ colorimetric system which is measured at a viewing angle of 2° using the C light source (color temperature: 2740 K) according to JIS Z 8701 to give a luminous reflectance (Y value).

The following Table 1 shows evaluation results of (1) fingerprint visibility, (2) reflection of external light, and (3) luminous reflectance.

TABLE 1

| Bottom wavelength | Fingerprint | Reflection of | Luminous reflectance |
|---|---|---|---|
| [nm] | visibility | external light | [%] |
| 450 | Good | Bad | 1.72 |
| 480 | Good | Average | 1.66 |
| 500 | Excellent | Good | 1.65 |
| 510 | Excellent | Excellent | 1.64 |
| 520 | Excellent | Excellent | 1.63 |
| 530 | Excellent | Excellent | 1.62 |
| 540 | Good | Excellent | 1.61 |
| 550 | Agerage | Excellent | 1.61 |
| 560 | Average | Excellent | 1.61 |
| 580 | Bad | Excellent | 1.61 |
| 600 | Bad | Excellent | 1.64 |
| 630 | Bad | Bad | 1.69 |

As shown in Table 1, the fingerprint on the film whose reflection spectrum had a bottom wavelength of 550 nm or more clearly appeared blue. In contrast, the fingerprint on the film whose reflection spectrum had a bottom wavelength of less than 550 nm had no problems in practical use. This must be because the bottom wavelength was previously set to be less than 550 nm, and thereby the change in reflectance of blue became smaller even if, due to optical synthesis of the fingerprint layer and the anti-reflective film, the bottom wavelength was shifted to the longer wavelength region. In addition, the fingerprint on the film whose reflection spectrum had a bottom wavelength of less than 540 nm was not recognized. This must be because the change in reflectance of blue became smaller. The fingerprint on the film whose reflection spectrum had a bottom wavelength of less than 500 nm was hardly observed although the luminous reflectance was high. This must be because the fingerprint was observed due to not an absolute value of the luminous reflectance but a difference in reflectance between a part where the fingerprint has adhered and a part where no fingerprint has adhered. In addition, with regard to the film whose reflection spectrum had a bottom wavelength of 500 nm to 530 nm, the luminous reflectance increased, but the reflection of external light had no problem. This might be because a few hundredth of a percent increase in luminous reflectance is so small change that human eyes can not recognize it, and therefore, such an increase has no influences on the reflection of external light.

In this test, the fingerprint was used as an evaluation object, but the same effects are expected in principle for different stains which have remained on the surface of the anti-reflective film after being wiped off.

The present application claims priority under the Paris Convention and the domestic law in the country to be entered into national phase on Patent Application No. 2006-220019 filed in Japan on Aug. 11, 2006, the entire contents of which are hereby incorporated by reference.

In the present description, if the term “or more” is used, the value described (boundary value) is included.

### BRIEF DESCRIPTION OF DRAWINGS

FIG. 1 is a graph schematically showing a change in reflection spectrum, due to adherence of a fingerprint, of the anti-reflective film of the present invention.

FIG. 2 is a cross-sectional view schematically showing a configuration of the display element of the present invention (Embodiment 1), and the display element includes an LR film as the anti-reflective film.

FIG. 3 is a view for explaining a coating method of the anti-reflective film (LR film) of the present invention, FIG. 3(a) shows a kiss reverse method. FIG. 3(b) shows a wire bar method. FIG. 3(C) shows a slit die method.

FIG. 4 is a cross-sectional view schematically showing a configuration of the display element of the present invention (Embodiment 2), and the display element includes an AGLR film as the anti-reflective film.

FIG. 5 is a graph showing an improvement in characteristics of the AGLR film.

FIG. 6 is a cross-sectional view schematically showing a configuration of the display element of the present invention (Embodiment 3), and the display element includes an AR film as the anti-reflective film.

FIG. 7 is a cross-sectional view schematically showing a configuration of the conventional display element including an AG film.

FIG. 8 is a cross-sectional view schematically showing a configuration of the conventional display element including a clear film.

FIG. 9 is a graph showing a common reflection spectrum of a clear type anti-reflective film.

FIG. 10 is a graph schematically showing a change in reflection spectrum, due to adherence of a fingerprint, of a common clear type anti-reflective film.

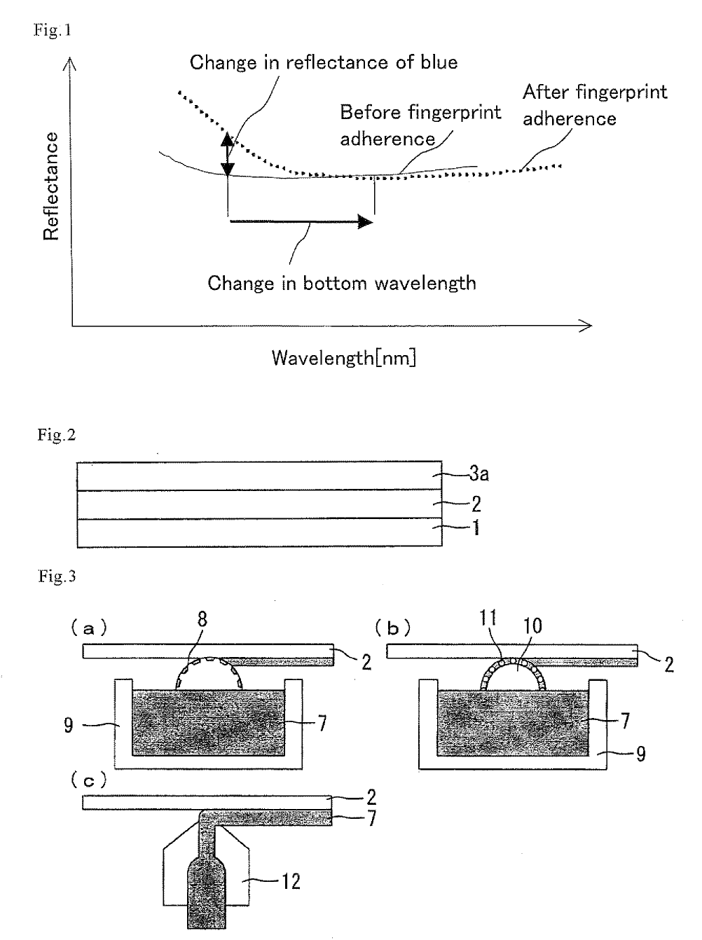

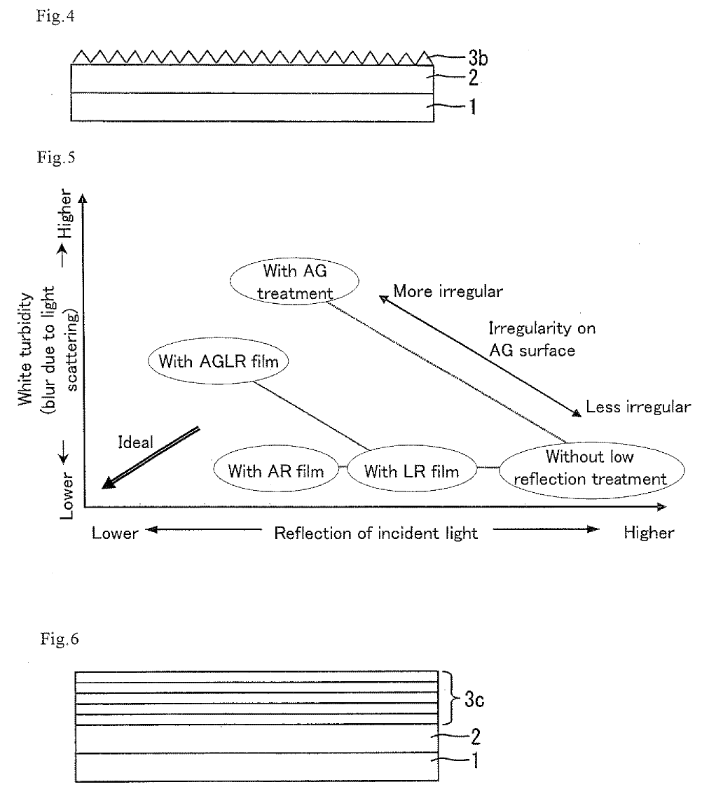

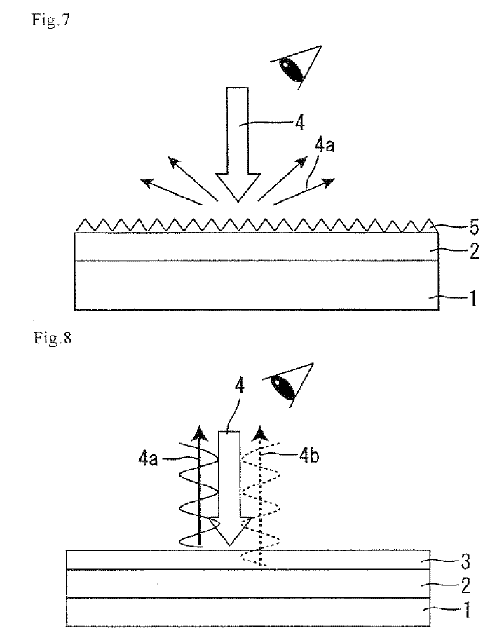

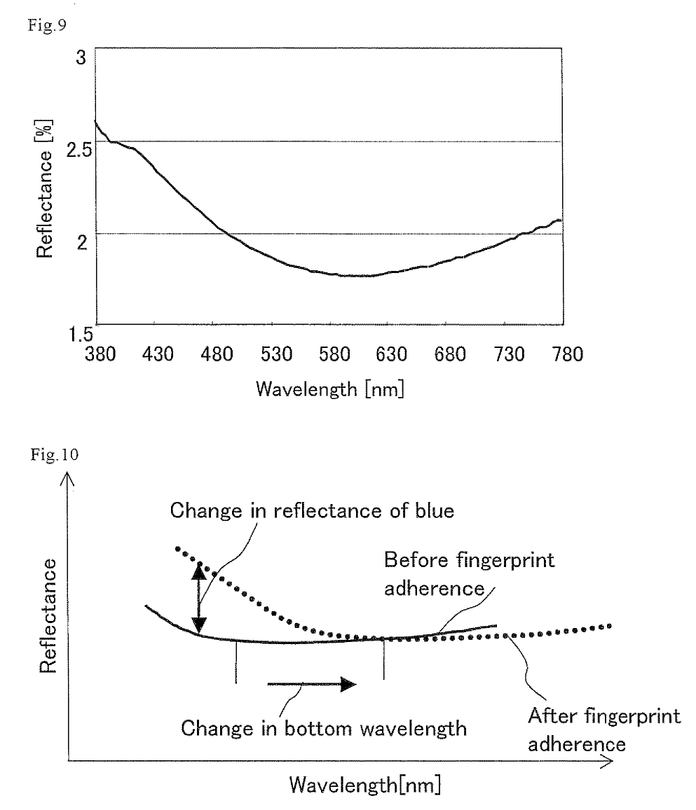

### EXPLANATION OF NUMERALS AND SYMBOLS

1: Display
2: Base material, base material film
3: Clear film (anti-reflective film)
3a: LR film (anti-reflective film)
3b; AGLR film (anti-reflective film)
3c: AR film (anti-reflective film)
4: External light
4a: Reflected light (reflection on the outermost surface of film)
4b: Reflected light (reflection on the boundary surface between clear film and base material)
5: AG film (anti-reflective film)
7: Coating liquid
8: Gravure
9: Coating liquid-filled container
10: Shaft
11: Wire
12: Die

1. An anti-reflective film which is placed on a base material and reduces light reflected on a surface of the base material,
wherein a reflection spectrum of the anti-reflective film has a bottom wavelength of less than 550 nm.

2. The anti-reflective film according to claim 1,
wherein the reflection spectrum of the anti-reflective film has a bottom wavelength of more than 500 nm.

3. The anti-reflective film according to claim 1,
wherein the anti-reflective film is composed of a single layer.

4. The anti-reflective film according to claim 1,
wherein the anti-reflective film is composed of two or three layers.

5. The anti-reflective film according to claim 1,
wherein the anti-reflective film is composed of four or more layers.

6. The anti-reflective film according to claim 1,
wherein a surface of the anti-reflective film is provided with a light scattering anti-glare treatment.

7. A polarizer comprising the anti-reflective film of claim 1.

8. A liquid crystal display element comprising the polarizer of claim 7.

9. The liquid crystal display element according to claim 8,
wherein the anti-reflective film is arranged on an outermost surface of the liquid crystal display element.

10. A display element comprising the anti-reflective film of claim 1.

11. The display element according to claim 10,
wherein the anti-reflective film is arranged on an outermost surface of the display element.
